(19) United States
(12) Patent Application Publication
(10) Pub. No.: US 2015/0208619 A1
(43) Pub. Date: Jul. 30, 2015

(54) Temperature Regulated Automatic Aquarium Feeder

(71) Applicant: JOSHUA DEVON NOBLE, FORT WORTH, TX (US)

(72) Inventor: JOSHUA DEVON NOBLE, FORT WORTH, TX (US)

(21) Appl. No.: 14/606,816

(22) Filed: Jan. 27, 2015

Related U.S. Application Data
(60) Provisional application No. 61/931,914, filed on Jan. 27, 2014.

(51) Int. Cl. A01K 61/02

(52) U.S. Cl. CPC A01K 61/025

(57) ABSTRACT

A Temperature Regulated Automatic Aquarium Feeder includes an insulated container, temperature regulating elements, and dispensing elements for the temperature controlled storage and feeding of temperature sensitive foods to aquariums. Temperature sensitive foods such eggs, shrimp, copepods, amphipods, rotifers, or microalgae are placed into an insulated container. The insulated container is heated or cooled by use of temperature regulating elements such as a thermoelectric elements, heat sinks, and electric fans. Food is released through opening of a valve or piston in gravity fed models, or pulled out of the insulated container with a pump in alternative configurations. The schedule of food release is controlled through an automatic timer or digital controller.

### 1. FIELD OF THE INVENTION

This invention relates to devices for automatic dispensing of fish food, and in particular, to systems for dispensing food stored to at least one predetermined temperature.

### 2. DESCRIPTION OF RELATED ART

Aquariums housing fish, invertebrates, corals, plants, and other aquatic creatures are widely used for decorative or scientific purposes in locations such as homes, businesses, schools, laboratories, zoos and other venues. Aquarium owners have the option to manually feed their aquatic organisms several types of food, such as dry flakes, pellets, living, fresh refrigerated, or frozen foods. Alternatively, an automated feeder may be used to feed aquatic organisms at predetermined times.

Automated feeding devices for aquariums are widely used and are made by a variety of manufacturers. Such automated feeding devices have varied configurations including varying capacities, multiple chambers for differing foods, and a variety of control mechanisms. Most automated aquarium feeders are placed above the surface water of an aquarium and employ a receptacle bin for holding dry, flake or pellet food. This bin, which includes an adjustable top hole, is mounted horizontally on a motorized control chassis. At predetermined times; a motor in the chassis rotates the bin through a full revolution, allowing food to fall from the bin as the hole passes over the aquarium.

Fish, corals, anemones and other creatures may have nutritional requirements which are better satisfied with the use of live, fresh, frozen or refrigerated foods. Examples include temperature sensitive foods such as eggs, shrimp, copepods, amphipods, rotifers, or microalgae. Some temperature sensitive food, such as live copepods, need to be stored in an environment which is generally warmer than the surrounding area, while other foods require refrigeration. Existing conventional aquarium feeders, such as those discussed above, are not able to feed these types of foods as they do not address the issue of temperature control.

Consequently, a Temperature Regulated Automatic Aquarium Feeder and method for dispensing temperature sensitive food to an aquarium is desired.

### BRIEF SUMMARY OF THE INVENTION

It is therefore, an object of the present invention, to provide a novel apparatus and method for dispensing aquarium food, where such food is kept at a temperature above or below the surrounding environment until dispensed.

In accordance with one embodiment of the invention, a Temperature Regulated Automatic Aquarium Feeder is positioned above or adjacent to the surface water of an aquarium or aquarium container. The feeder includes an insulated container and insulated lid which envelops, thermally insulates, and retains the food. Inside the insulated container are one or more vertical compartments which are filled with a predetermined quantity of temperature sensitive food.

In one embodiment, the bottom of the food storage compartment is tapered so that contents are funneled to a central point. The bottom of the insulated container contains an aperture through the insulated container. In another embodiment, the top of the insulated container contains an aperture through the insulated container. A bulkhead extends between the interior and exterior sides of the insulated container, through the bottom aperture. Flexible tubing extends through the bulkhead, from the interior of the insulated container to the exterior of the insulated container. The flexible tubing leads to the dispensing elements outside the insulated container.

In this system, one or more dispensing elements control the release of food from the insulated container at a predetermined rate. The dispensing elements may comprise a valve, piston, rotary wheel, or pump controlled by programmable control circuitry. The dispensing elements cause the food to fall or be pulled from the insulated container at one or more predetermined rates, or at least one predetermined time.

In this system, the interior temperature of the insulated container, and food storage compartments within, is maintained at a level above or below the surrounding environment through the use of temperature regulating elements. In one embodiment, the temperature regulating elements comprise one or more thermoelectric elements used in conjunction with a heat sink and an electric fan. One or more temperature regulating elements are mounted on the outside of the insulated container. The temperature regulating elements are mounted so as to disperse the undesired temperature away from the insulated container, and away from the apparatus. One of more temperature plates are inserted into the wall of the insulated container, connecting the temperature regulating elements to the interior of the insulated container. The temperature sensitive plate retains the water tight seal of the insulated container, while allowing heat transfer at the dissecting points. In one embodiment, the temperature sensitive plate is further assisted in transferring the temperature of the temperature regulating elements into the insulated container through temperature sensitive rods.

In one embodiment, food is agitated with one or more mixing elements. The mixing elements may comprise an auger, rotary wheel, vibrator, shaker, or motor which directly move food within the insulated container. The mixing elements may also comprise an auger, rotary wheel, vibrator, shaker, or motor which move or rotate insulated container thus indirectly moving food within the insulated container.

In one embodiment, The Temperature Regulated Automatic Aquarium Feeder is covered by a water resistant, non-corrosive, exterior housing, molded to fit, support, and retain the interior elements of the feeder. In one embodiment, the exterior housing includes exterior mounting brackets, interior mounting brackets for securing interior components, sealed ports for temperature regulating element power connections, sealed ports for dispensing element power connections, and vents for heat dispersal.

With these apparatus and method aspects of the present invention, temperature regulated food is dispensed in an aquarium at a predetermined schedule while preserving the food in its temperature controlled state.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1A. shows one embodiment of a Temperature Regulated Automatic Aquarium Feeder in relation to an aquarium.

FIG. 1B. shows a second embodiment of a Temperature Regulated Automatic Aquarium Feeder, including exterior tubing, in relation to an aquarium.

FIG. 2. illustrates a vertical cross-sectional view of another embodiment of a Temperature Regulated Automatic Aquarium Feeder, including a single food storage compartment and a solenoid valve.

FIG. 3. illustrates a vertical cross-sectional view of another embodiment of a Temperature Regulated Automatic Aquarium Feeder, including multiple food storage compartments, solenoid valves, and temperature regulating elements.

FIG. 4. illustrates a vertical cross-sectional view of another embodiment of a Temperature Regulated Automatic Aquarium Feeder, including a single peristaltic pump below the apparatus.

FIG. 5. illustrates a vertical cross-sectional view of another embodiment of a Temperature Regulated Automatic Aquarium Feeder, including a single peristaltic pump above the apparatus.

FIG. 6. illustrates a vertical cross-sectional view of another embodiment of a Temperature Regulated Automatic Aquarium Feeder, including a single food storage compartment, a single solenoid valve, and a single auger with electric motor.

FIG. 7A. shows one embodiment of a temperature regulating element sub-assembly including a thermoelectric element, heat sink, and electric fan.

FIG. 7B. shows one embodiment, in an alternative perspective, of a temperature regulating element sub-assembly including a thermoelectric element, heat sink, and electric fan.

FIG. 7C. shows one embodiment of a temperature regulating element sub-assembly including a thermoelectric element and heat sink.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION AND BEST MODE OF IMPLEMENTATION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The embodiments herein and the various features and advantageous details thereof are explained more fully with reference to the non-limiting embodiments that are illustrated in the accompanying drawings and detailed in the following description. Descriptions of well-known components and processes and manufacturing techniques are omitted so as to not unnecessarily obscure the embodiments herein. The examples used herein are intended merely to facilitate an understanding of ways in which the invention herein may be practiced and to further enable those of skill in the art to practice the embodiments herein. Accordingly, the examples should not be construed as limiting the scope of the claimed invention.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

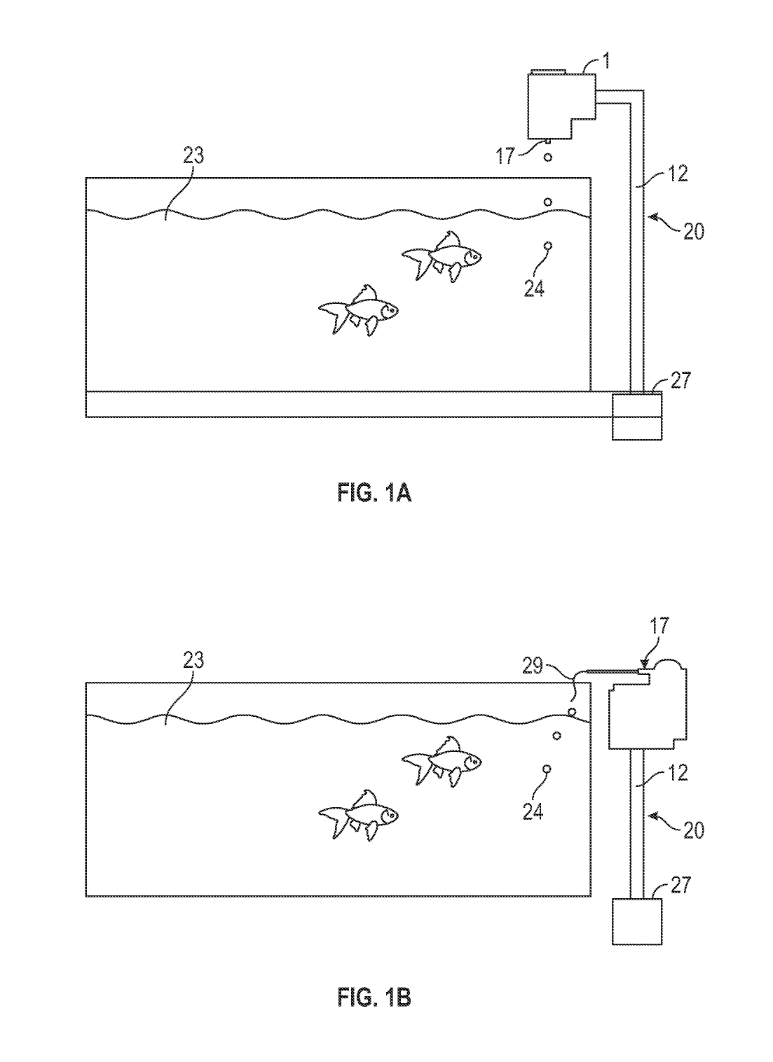

FIG. 1A illustrates a Temperature Regulated Automatic Aquarium Feeder 1 positioned above the surface water of an aquarium 23. Aquarium 23 may be either a fresh water aquarium or a saltwater aquarium. Aquarium 23 may be any residential, commercial, educational, zoological, or industrial aquarium, and may be used to keep fish or other aquatic organisms. Aquarium 23 may be of any predetermined size. Aquarium 23 may be any sump, refugium, or container integrated with an aquarium. Temperature regulated food element 24 is shown in FIGS. 1A and 1B being dispensed into aquarium 23. Food element 24 may be any conventional form of temperature sensitive food suitable for salt water or marine fish, fresh water fish, aquatic plants, corals, or other aquatic organisms. Alternatively, food element 24 may be any mixture of a plurality of types of temperature sensitive food suitable for fish or other aquatic creatures, or may be any nutrition supplement, medicine, fungicide, water conditioner, or other additive appropriate for aquarium 23 or the organisms being kept therein.

As shown in FIG. 1A, Temperature Regulated Automatic Aquarium Feeder 1 is positioned above or adjacent to aquarium 23 on a ledge, platform, or bracket. Temperature Regulated Automatic Aquarium Feeder 1 includes an exterior nozzle 17. Food element 24 is dispensed from feeder 1, through nozzle 17, and into aquarium 23. As shown in FIG. 1B, external tubing 29 may be connected to exterior nozzle 17 to direct food distribution. Temperature Regulated Automatic Aquarium Feeder 1 is positioned adjacent to aquarium 23 on a ledge, platform, or bracket. Food element 24 is dispensed from feeder 1, through nozzle 17, through external tubing 29, and into aquarium 23.

Feeder 1 is connected to power source 27, which may be any conventional power source, such as an electrical outlet, a battery or any commercial or industrial source of power. Power source 27 is connected to the control elements, dispensing elements, temperature regulating elements, and mixing elements comprising Temperature Regulated Automatic Aquarium Feeder 1 as appropriately required. Alternatively, power source 27 may be, for example, a battery integral or internally stored and mounted on, within, or as part of feeder 1.

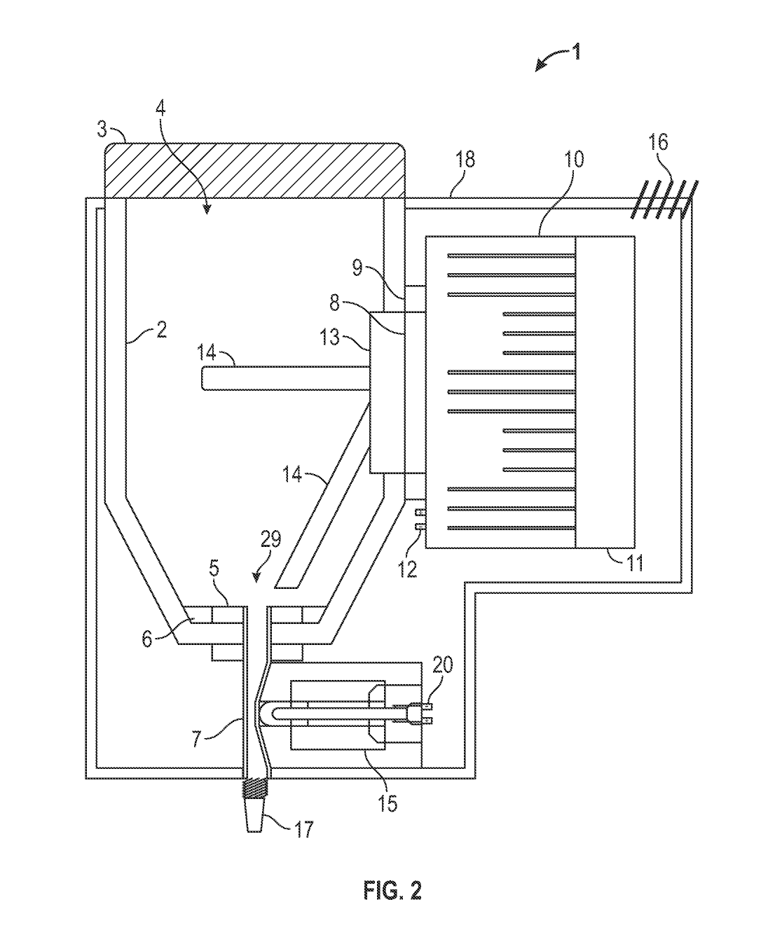

FIG. 2 illustrates a vertical cross-sectional view of another embodiment of a Temperature Regulated Automatic Aquarium Feeder 1, including a single food storage compartment 4, insulated lid 3, and a single solenoid valve 15. In this embodiment, feeder 1 includes an insulated container 2, which envelops and thermally insulates the food storage compartment 4 of the feeder. The bottom of the food storage compartment 4 is tapered, so that contents are funneled to a central point. The bottom of the insulated container 2 contains an aperture 29 through the insulated container 2. A bulkhead 5 extends between the interior and exterior sides of the insulated container 2, through the bottom aperture 29. A tapered insert 6 fills the gap between the interior bulkhead 5 and the insulated container 2. Flexible tubing 7 extends through the bulkhead 5, from the interior of the insulated container 2 to the exterior of the insulated container 2. As discussed below, the flexible tubing 7 leads to the dispensing elements below the insulated container 2.

As shown in FIGS. 2, 3, 4, 5, and 6 the thermally insulated container 2 creates a threaded seal with insulated lid 3. Alternatively one or more hinges may connect thermally insulated lid 3 to insulated container 2 so that they form a clamshell, or similar shape, which can be opened to gain access to food storage container 4.

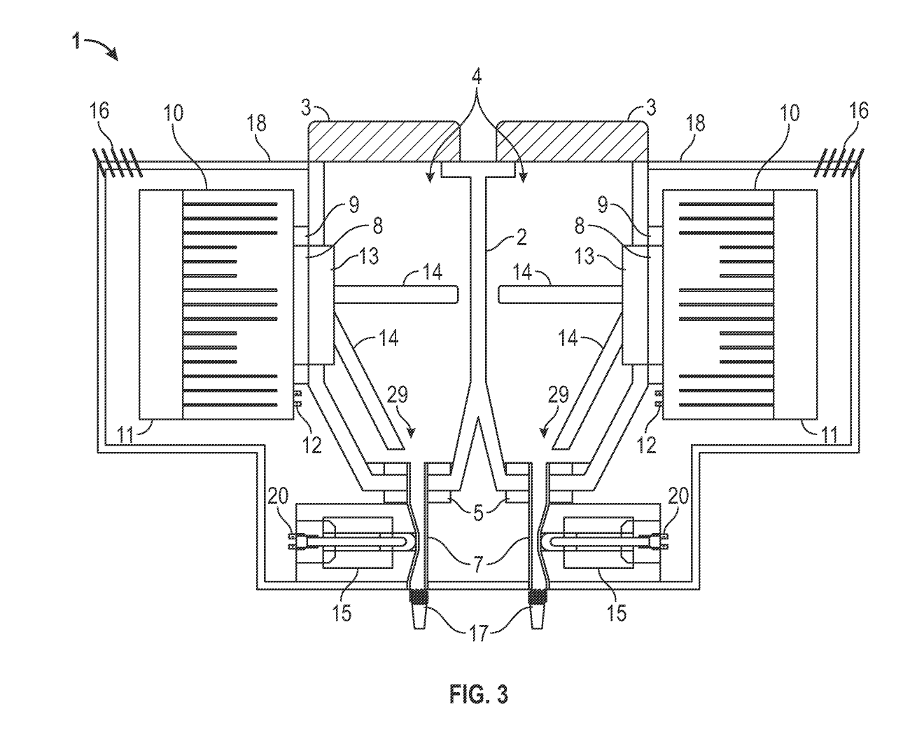

FIG. 3 illustrates a vertical cross-sectional view of a Temperature Regulated Automatic Aquarium Feeder 1, including multiple food storage compartments 4, lids 3, and multiple solenoid valves 15, in accordance with an embodiment of this invention. In one embodiment, the feeder 1 includes an insulated container 2, which envelops and thermally insulates the food storage compartments 4 of the feeder. Multiple food storage compartments 4 are created by vertically subdividing the food storage container 2 by using a shared wall of insulated container 2 or with regularly-spaced divider walls (i.e. between each food storage compartment 4 and its neighbors). Lids 3 are located above each food storage compartment 4 to insulate and access each compartment 4. The bottom of each food storage compartment 4 is tapered, so that contents are funneled to a central point. The bottom of the insulated container 2 contains an aperture 29 through the insulated container 2 below each food storage compartment 4. Bulkheads 5 extend between the interior and exterior sides of the insulated container 2, through each bottom aperture 29. A tapered insert 6 fills the gap between the interior bulkhead 5 and the insulated container 2. Flexible tubing 7 extends through each bulkhead 5, from the interior of the insulated container 2, to the exterior of the insulated container 2. As discussed below, the flexible tubing 7 leads to the dispensing elements below the insulated container.

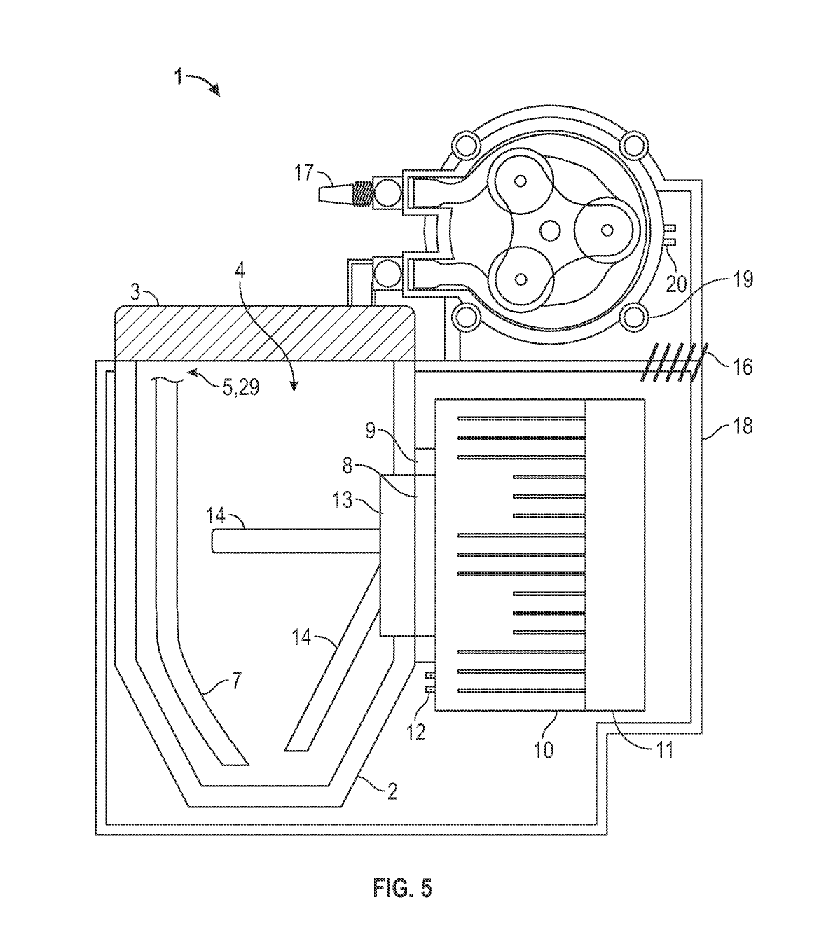

FIG. 5 illustrates a vertical cross-sectional view of another embodiment of a Temperature Regulated Automatic Aquarium Feeder 1, including a pump 19 above the feeder 1. In one embodiment, the insulated food container 2 is fashioned to contain one or more food storage compartments 4 with lids 3 as described above. The top of each compartment 4 contains an aperture 29 through the insulated container 2. A bulkhead 5 extends between the interior and exterior sides of the insulated container 2, through the aperture 29. Flexible tubing 7 extends through the bulkhead, from the interior of the insulated container 2 to the exterior of the insulated container 2. As discussed below, the flexible tubing 7 leads to the dispensing elements outside the insulated container.

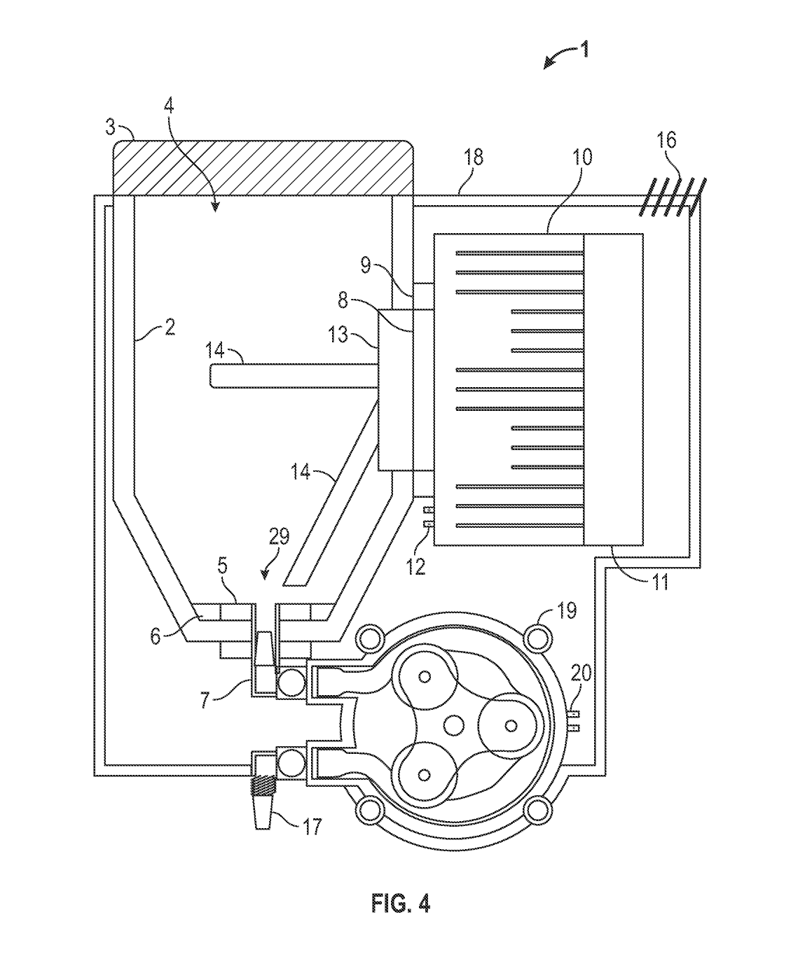

In the illustrated embodiments of this application, the different systems include one or more dispensing elements control the release of food from the insulated container 2 at a predetermined rate. The dispensing elements may comprise a valve 15 (shown in FIGS. 2, 3, and 6), pump 19 (shown in FIGS. 4 and 5), or piston controlled by programmable control circuitry. The dispensing elements cause the food to fall or be pulled from the insulated container 2 at a predetermined rate or at predetermined times.

Feeder 1 of FIG. 2 illustrates a vertical cross-sectional view of the Temperature Regulated Automatic Aquarium Feeder 1, including a single food storage compartment 4, insulated lid 3, and a single solenoid valve 15. In the embodiment, the dispensing elements comprise a valve 15 or piston, a controllable valve 15 or piston is located below the insulated container 2. The flexible tubing 7, at the bottom of the insulated container 2, is connected to the valve 15 or piston so that the contents of the insulated container 2 can flow through the valve 15 or piston. At a predetermined schedule, the valve 15 or piston opens and dispenses the temperature sensitive food 24 out of the insulated container 2 by moving downward, through the space defined by the compartment 4, through aperture 29 in the bottom of the insulated container 2, through the valve 15 or piston, through the exterior nozzle 17, and ultimately out the bottom of the apparatus, and thus into the aquarium.

Feeder 1 of FIG. 4 illustrates a vertical cross-sectional view of a Temperature Regulated Automatic Aquarium Feeder 1, including a single food storage compartment 4, insulated lid 3, and a single pump 19 located at the bottom of the apparatus. In this embodiment, the dispensing elements comprise a pump 19, a controllable pump 19 is located below the insulated container 2. The flexible tubing 7, at the bottom of the insulated container 2, is connected to the pump 19 so that the contents of the insulated container 2 can flow through the pump 19. At a predetermined schedule, the pump 19 turns and dispenses the temperature sensitive food 24 out of the insulated container 2, through the space defined by the compartment 4, through aperture 29 in the insulated container 2, through the pump 19, through the exterior nozzle 17, and ultimately out the bottom of the apparatus, and thus into the aquarium.

Feeder 1 of FIG. 5 illustrates a vertical cross-sectional view of a Temperature Regulated Automatic Aquarium Feeder 1, including a single food storage compartment 4, and lid 3, and a single pump 19 located at the top of the apparatus. In this embodiment, the dispensing elements comprise a pump 19, a controllable pump 19 is located above the insulated container 2. The flexible tubing 7, at the top of the insulated container 2, extends to the bottom of food storage compartment 4. The flexible tubing 7 is connected to the pump 19 so that the contents of the insulated container 2 can flow through the pump 19. At a predetermined schedule, the pump 19 turns and dispenses the food 24 out of the insulated container 2, through the space defined by the compartment 4, through aperture 29 in the insulated container 2, through the pump 19, through the exterior nozzle 17, and ultimately out of the apparatus, and thus into the aquarium.

In this system of selectively dispensing temperature regulated food, one or more a mixing elements may be used to stir, agitate, or mix the temperature sensitive food 24 stored within food storage compartment 4 at a constant or predetermined schedule. The mixing elements may comprise an auger, rotary wheel, vibrator, shaker, or motor which directly move food within the insulated container 2. The mixing elements may also comprise an auger, rotary wheel, vibrator, shaker, or motor which indirectly move or rotate insulated container, thus moving food within the insulated container 2.

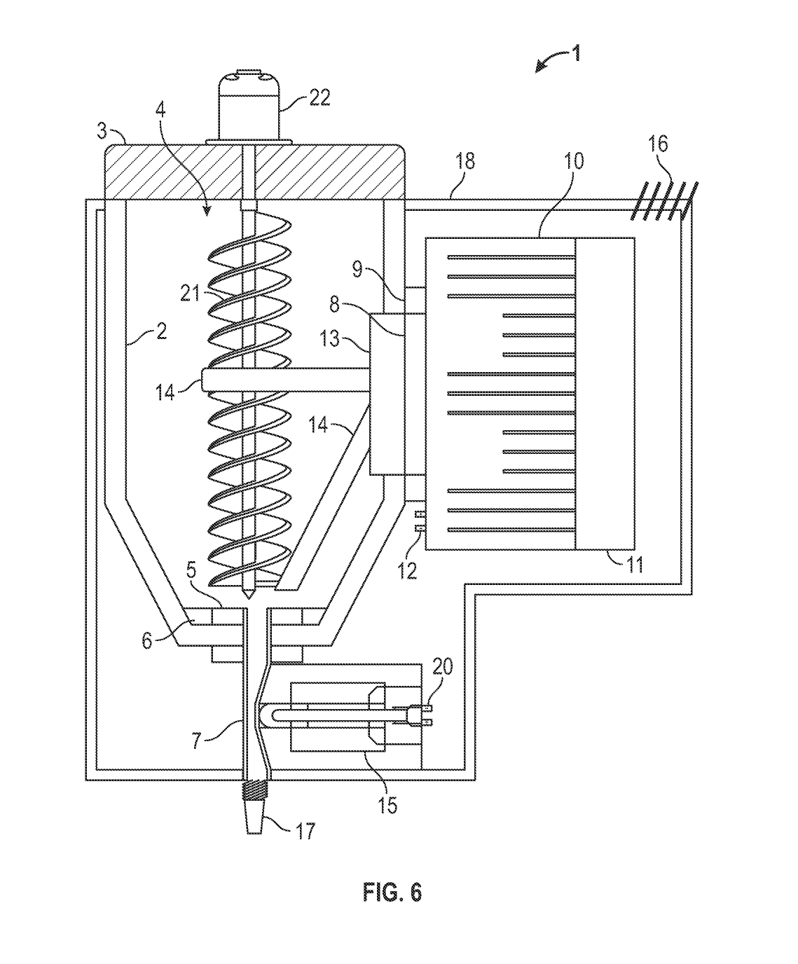

Feeder 1 of FIG. 6 again illustrates a vertical cross-sectional view of an embodiment of Temperature Regulated Automatic Aquarium Feeder 1 in which a mixing element is used to stir, agitate, or mix the food 24. Temperature Regulated Automatic Aquarium Feeder 1 includes a single food storage compartment 4, insulated lid 3, a single solenoid valve 15, a single auger 21, and a single electric motor 22. The illustrated embodiment of FIG. 6 is similar in form and function to that of the illustrated embodiment of FIG. 2. In this embodiment, the electric motor 22 is attached to the top of insulated lid 3. The auger 21 is attached to the electric motor 22, through the insulated lid 3, and extends down into food storage compartment 4. When the electric motor 22 is energized, it rotates the auger 21 within food storage compartment 4, and in turn mixes the temperature sensitive food 24.

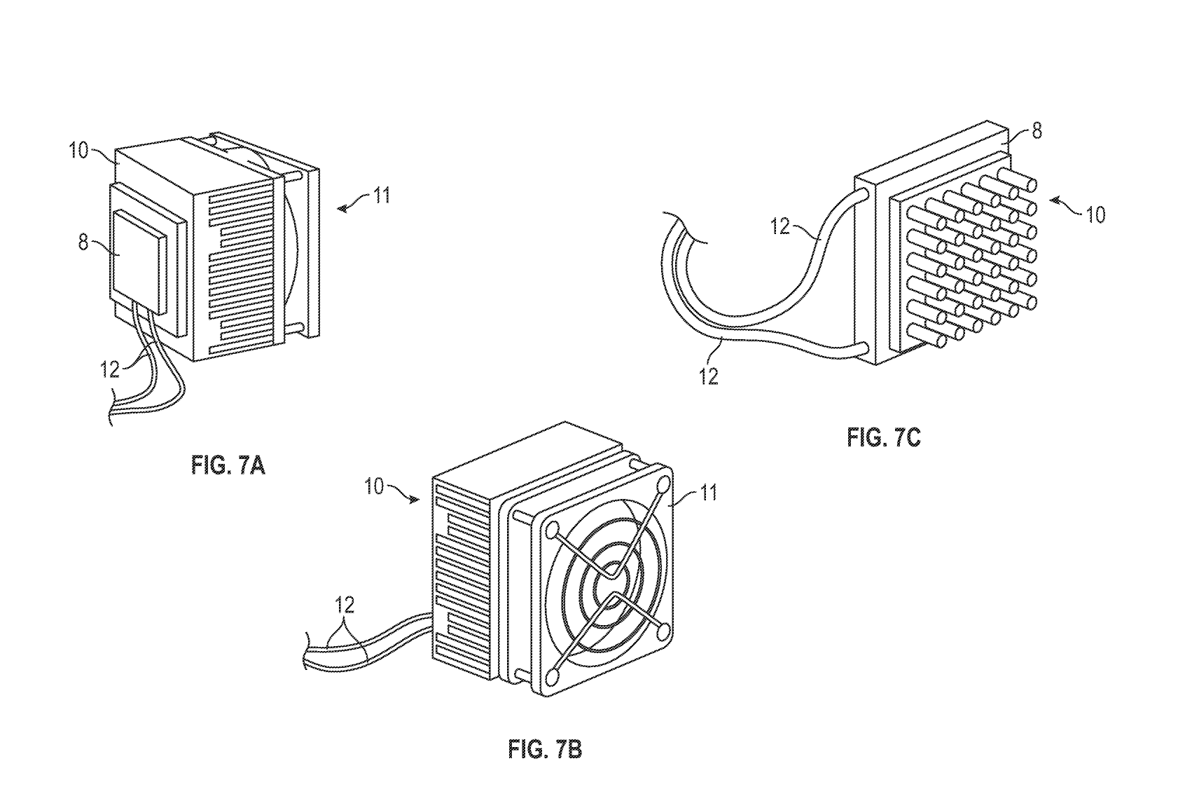

The interior temperature of the insulated container 2, and food storage compartments 4 within of the above described embodiments, are maintained at one or more temperature levels through the use of temperature regulating elements. In one embodiment, the temperature regulating elements comprise one or more thermoelectric elements 8. In another embodiment, the temperature regulating elements comprise one or more thermoelectric elements 8 used in conjunction with a heat sink 10. In another embodiment, shown in FIGS. 7A & 7B, and illustrated in FIGS. 2, 3, 4, 5, and 6, the temperature regulating elements comprise one or more thermoelectric elements 8, used in conjunction with a heat sink 10, and electric fan 11. In another embodiment, the temperature regulating elements comprise one or more thermoelectric elements used in conjunction with pipes filled with refrigerant.

A thermoelectric element is an electrical device which uses the Peltier effect to create a heat flux between the junctions of two different materials. While the temperature of one material increases, the temperature of the other material decreases. The thermoelectric element can be reversed as necessary to achieve either a cooling or warming effect on a target surface. A heat sink 10 and electric fan 11 can dissipate heat of the warm material. In one embodiment, a heat sink 10 is fashioned of copper due to its high thermal conductivity and corrosion resistance. In an alternative embodiment, heat sink 10 may be fashioned from an aluminum alloy or composite material.

FIGS. 2, 3, 4, 5, 6, 7A, 7B, and 7C illustrate different temperature regulating elements and their use within the systems as described in the embodiments above. One or more temperature regulating elements are mounted on the outside of the insulated container 2. In one embodiment of the apparatus, the temperature regulating elements are mounted so as to draw heat away from the insulated container 2, and away from the apparatus. When electricity is applied, the thermoelectric elements 8, reduce temperature on the side facing the insulated container 2, and inversely increase temperature on the opposite surface. The heat sink 10, absorbs and spreads the heat generated by the thermoelectric elements 8. The electric fan 11, dissipates heat away from the heat sink and Temperature Regulated Automatic Aquarium Feeder 1. Potting sealant 9 surrounds the area around the thermoelectric elements 8, between the insulated container and heat sink, to maximize insulation. In another embodiment of the apparatus, when electricity is applied, the thermoelectric elements 8, increase temperature on the side facing the insulated container 2, and inversely decrease temperature on the opposite surface.

One or more temperature sensitive plates 13 are inserted into the wall of the insulated container, connecting the temperature regulating elements to the food storage compartments 4. The temperature sensitive plate 13 retains the water tight seal of the insulated container 2, while allowing heat transfer between food storage compartment 4 and the temperature regulating elements. The temperature sensitive plate 13 transfers the desired temperature of the temperature regulating elements into the insulated container. In one embodiment, temperature plates 13 line the interior of insulated container 2. In another embodiment, shown in FIGS. 2, 3, 4, 5, and 6 temperature sensitive rods 14 connect to temperature sensitive plate 13, aiding in the even dispersal of temperature transfer.

The temperature regulating elements and dispensing elements are appropriately configured to receive power from power source 27. The dispensing elements and temperature regulating elements are powered and controlled independently of each other. Separate electronic relays are contained within the apparatus to govern both the dispensing and temperature regulating elements. Temperature regulating element power connections 12 are illustrated in all FIGS. Dispensing element power connections 20 are illustrated in FIGS. 1A, 1B, 2, 3, 4, 5, and 6. Separate power plugs are used on the apparatus to independently control dispensing elements and temperature regulating elements. For example, temperature regulating elements may receive constant power, while the electricity to activate dispensing elements may be regulated through a separate timer or controller.

As seen in FIG. 2-5, Temperature Regulated Automatic Aquarium Feeder 1 is covered by a water resistant, non-corrosive, exterior housing 18, molded to fit, support, and retain the interior elements of the feeder 1. The exterior housing 18 includes exterior mounting brackets, interior mounting brackets for securing interior components, sealed ports for temperature regulating element power connections 12, sealed ports for dispensing element power connections 20, and top vents 16 for heat dispersal.

With these apparatus and method aspects of the present invention, temperature regulated food is dispensed in an aquarium at one or more predetermined schedules while preserving the food in one or more temperature controlled states.

While the above disclosure of the invention has been particularly shown and described with reference to particular embodiments thereof, it will be understood by those skilled in the art that the foregoing and other changes in form and detail may be made therein without departing from the spirit and scope of the invention. Specific dimensions discussed with respect to particular embodiments above are not intended to limit the scope of the invention, but to illustrate specific embodiments of the invention. The above descriptions are only examples of the invention's applications and should not be taken as limitations.

Many elements and subassemblies described above could be chosen or arranged differently while still embodying the present invention. While those of ordinary skill will appreciate interchangeable substitutions for the elements discussed above, examples of alternative embodiments include but are not limited to:
different numbers of thermoelectric elements 8, heat sinks 10, fans 11, valves 15, pumps 19, food storage compartments 4, lids 3, vents 16, temperature sensitive plates 13, or temperature sensitive rods 14, nozzles 17, bulkheads 5, electric motors 22, or augers 21;
different geometrical arrangement of the collection of compartments 4;
other control circuitry to control the operation of temperature regulating elements, dispensing elements, or mixing elements;
different geometrical shapes for each compartment 4;
different placement of insulated container aperture 29, thermoelectric elements 8, heat sinks 10, fans 11, valves 15, pumps 19, food storage compartments 4, lids 3, vents 16, temperature sensitive plates 13, or temperature sensitive rods 14, nozzles 17, bulkheads 5, electric motors 22, or augers 21;
coating any or all the surfaces of insulated container 2, insulated lid 3, compartments 4, bulkhead 5, flexible tubing 7, temperature sensitive plates 13, temperature sensitive rods 14, valve 15, auger 21, or pump 19 with a suitable coating or resin to prevent sticking to food element 24;
different thickness or dimensions for the thermally insulating container 2 or exterior housing 18;
different material for insulated container 2, insulated lid 3, exterior housing 18, heat sink 10, temperature sensitive plates 13, or temperature sensitive rods 14;
different hardware or systems for programming or configuring temperature regulating elements, dispensing elements, or mixing elements; different valves 15, pumps 19, thermoelectric elements 8, augers 21, or electric motors 22; and
other predetermined schedules for the activation of dispensing elements or mixing elements.

Various adaptations and combinations of features of the embodiments disclosed are within the scope of the invention as defined by the following claims.

What is claimed is:

1. An apparatus to maintain and dispense aquarium food stored to at least one predetermined temperature, comprising:
a thermally insulated container having at least one interior compartment;
one or more compartments arranged within the interior of said container, said compartments each capable of containing at least one predetermined quantity of food;
one or more dispensing elements for dispensing, on at least one predetermined schedule, said foods; and
one or more temperature regulating elements for maintaining the interior of the container to at least one predetermined temperature.

2. The apparatus of claim 1 wherein the temperature regulating elements comprise one or more thermoelectric elements.

3. The apparatus of claim 2 wherein the temperature regulating elements further comprise one or more heat sinks.

4. The apparatus of claim 3 wherein the heat sink further comprises one or more fans.

5. The apparatus of claim 1 wherein the temperature regulating elements comprise one or more thermoelectric elements and pipes filled with refrigerant.

6. The apparatus of claim 1 wherein the dispensing elements comprises one or more valves and valve controllers.

7. The apparatus of claim 1 wherein the dispensing elements comprises one or more pumps and pump controllers.

8. The apparatus of claim 1 wherein the dispensing elements comprises one or more pistons and piston controllers.

9. The apparatus of claim 1 wherein the mixing elements comprises one or more augers and motors.

10. The apparatus of claim 1 wherein the mixing elements comprises one or more air tubes and air pumps.

11. The apparatus of claim 1 wherein the mixing elements comprises one or more devices for agitating aquarium food.

12. The apparatus of claim 1 wherein;
said dispensing elements, in an active state, move food out of said interior chamber;
whereby said food is dispensed out of said interior chamber into an aquarium on one or more predetermined schedules.

13. An apparatus for dispensing temperature regulated aquarium food comprising:
a container for thermally insulating one or more predetermined quantities of aquarium food;
a lid for periodically removing the aquarium food stored within the container, a dispensing element configured to selectively dispense the aquarium food out of the container; and
a temperature regulating element configured to maintain the interior temperature of the container to at least one or more predetermined temperatures.

14. The apparatus of claim 13 wherein said temperature regulating element comprises one or more thermoelectric modules.

15. A method for dispensing at least one temperature regulated food in an aquarium comprising:
arranging at least one predetermined quantity of temperature regulated foods in one or more compartments within an insulated container; and
dispensing said food from the container on at least one predetermined schedule; and
maintaining at least one temperature within the insulated container such that the food remains unspoiled.

16. The method of claim 15 wherein maintaining at least one regulated temperature further comprises cooling or heating the system with at least one thermoelectric element.

17. The method of claim 15 wherein maintaining at least one regulated temperature further comprises dissipating heat from one or more thermoelectric elements through one or more heat sinks.

18. The method of claim 15 wherein maintaining at least one regulated temperature comprises one or more thermoelectric elements and pipes filled with refrigerant.
